(19) United States
(12) Patent Application Publication
(10) Pub. No.: US 2009/0015563 A1
(43) Pub. Date: Jan. 15, 2009

(54) STYLIZED INTERACTIVE ICON FOR PORTABLE MOBILE COMMUNICATIONS DEVICE

(76) Inventor: JOHN THOMAS SADLER, Wake Forest, NC (US)

Correspondence Address: WILLIAMS MULLEN, P.O. Box 12109, Research Triangle Park, NC, 27709-2109, US

(21) Appl. No.: 11/775,921

(22) Filed: Jul. 11, 2007

(51) Int. Cl. G06F 3/041

(52) U.S. Cl. 345/173

(57) ABSTRACT

Disclosed is a portable mobile communications device having an integrated interactive touch sensitive graphical icon protective cover over an LCD display. The protective cover is integrated into the housing of the portable mobile communications device and forms a graphical image or icon that only partially obscures the LCD display allowing visual access to the unobscured portion of the LCD display. A touch sensitive layer is integrated into the protective cover and coupled with a processor that is further coupled with the LCD display. A program executable by the processor interprets touch and position data sensed by the touch sensitive layer and provides feedback or responses based thereon via the LCD display depending on a current mode of operation of the portable mobile communications device.

### BRIEF DESCRIPTION OF THE DRAWINGS

FIG. 1 is an illustration of a flip-type portable mobile communications device for one embodiment of the invention.

FIG. 2 is an illustration of a candy bar type portable mobile communications device for another embodiment of the invention.

FIG. 3 is a block diagram exploded cross-section view of the stylized interactive icon for one embodiment of the invention.

FIG. 4 is a block diagram view of components utilized for one embodiment of the invention.

FIG. 5 is one example of a stylized icon.

FIG. 6 is another example of a stylized icon of an embodiment for a music player application.

FIG. 7 is yet another example of a stylized icon of an embodiment for an ambient temperature application.

FIG. 8 is still another example of a stylized icon of an embodiment for a data transfer application.

### DETAILED DESCRIPTION OF EMBODIMENTS OF THE INVENTION

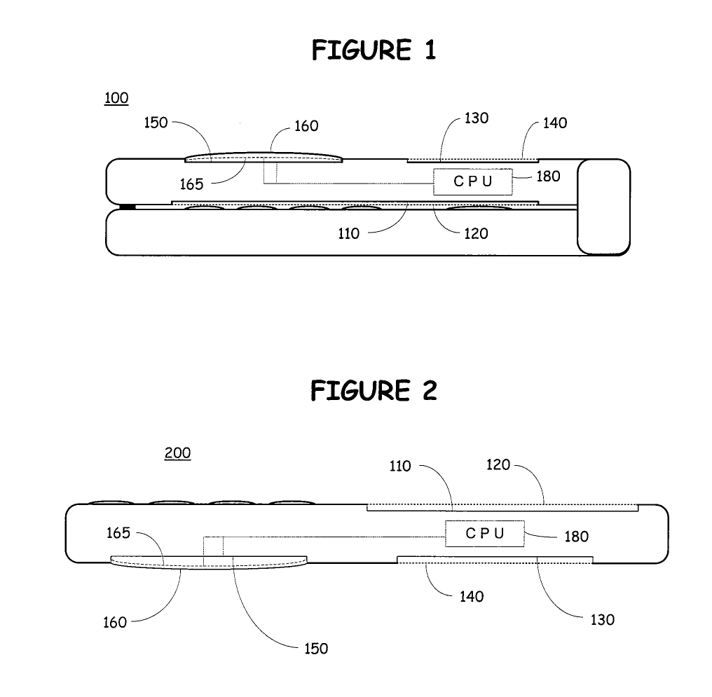

FIG. 1 is an illustration of a flip-type portable mobile communications device 100 in a closed position for one embodiment of the invention. The flip-type portable mobile communications device 100 includes a primary LCD screen 110 and protective covering 120 that is accessible when the flip-type portable mobile communications device 100 is in an open position. A secondary LCD screen 130 and protective covering 140 are integrated into the side opposite of the primary LCD screen 110 and its protective cover 120. In addition, a third LCD screen 150 and its protective cover 160 are included.

It should be noted that the second 130 and third 150 LCD screens may be combined into a single LCD screen that has separate protective covers 140, 160 that cover different portions of the LCD screen.

Protective covers 120 and 140 are typical clear coverings that substantially cover and protect the LCD screen from harm yet allow visibility to the screen. Protective cover 160, however, is different. Protective cover 160 can be an integrated contoured molding that combines the protective covering with the housing itself such as that employed by NISSHA™ Inc. under the name IMD™ (in mold decoration) or IML™ (in mold labeling). Using such technology, a contoured window NISSHA™ foil or two sided printing can be implemented to create a logo or design icon having a depth dimension that covers the area of LCD screen 150. The logo or icon can be created to meet the needs of virtually any design to provide another level of animation or graphical applications when combined into an application that also utilizes a touch sensitive layer 165 for the protective cover 160.

Protective cover 160 also includes an integrated touch sensitive layer 165 and allows for position sensoring and can be programmed to be responsive to certain sensed positions and/or sensed motion. One example of a touch or position sensitive layer 165 is a capacitive touch sensor system like that developed by NISSHA™ Inc. under the name Touch Screen™ or Touch Window™. Another example of a touch or position sensitive sensor mechanism includes scroll strip sensors, rotational scrolling sensors and light touch capacitive buttons like those developed by Synaptics™ Inc.

FIG. 2 is an illustration of a candy bar type portable mobile communications device 200 for another embodiment of the invention. The components described in FIG. 2 are the same as those described in FIG. 1 with the difference being the form factor of the portable mobile communications device.

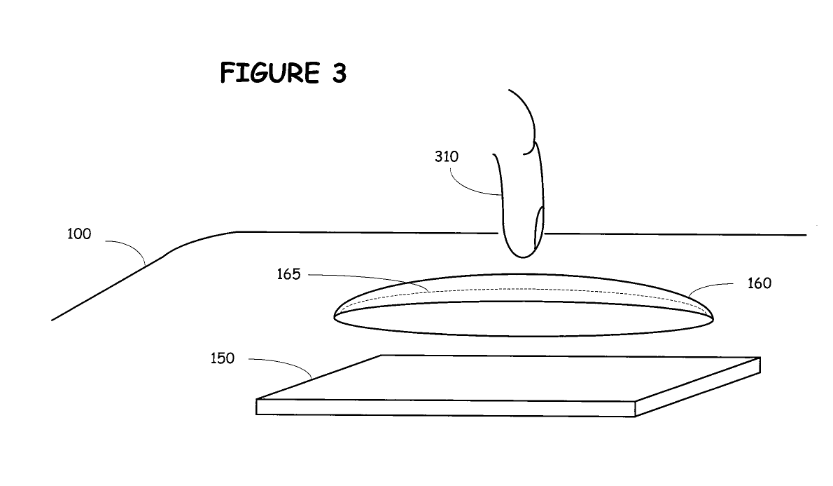

FIG. 3 is a block diagram exploded cross-section view of the stylized interactive icon for one embodiment of the invention. A section of the housing for a portable mobile communications device 100 is shown with a user's finger 310 approaching the touch sensitive protective cover 160 that covers the LCD screen 150. In operation, close proximity of the user's finger 310 to protective cover 160 can be sensed and tracked by the touch sensitive layer 165 of the protective cover 160.

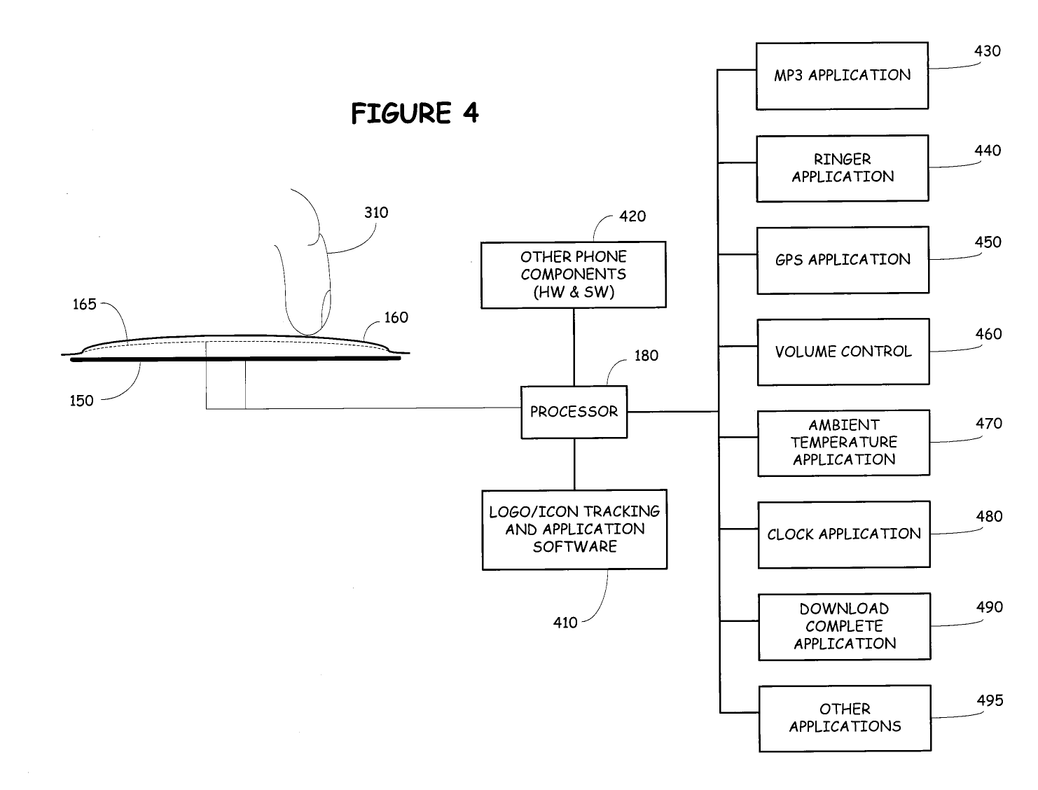

Referring to FIG. 4, the position/motion data is conveyed to processor 180. Processor 180 is further coupled with logo/icon tracking and application software 410 that interprets motion and position and provides feedback or responses based thereon depending on the current mode or application 430-495 that is utilizing the logo/icon touch sensitive layer 165 of the protective cover 160. The processor is also coupled with other hardware and software components 420 of the portable mobile communications device 100.

A non-exhaustive sampling of potential applications that can be made responsive to the logo/icon tracking and application software 410 includes but is not limited to, an MP3 (or other type of) music application/player 430, a ringer application 440, a GPS application 450, a volume control application 460, an ambient temperature sensor/application 470, a clock application 480, a data transfer application 490, as well as other unspecified applications 495.

The logo/icon tracking and application software 410 receives and processes input from the logo/icon touch sensitive layer 165 of the portable mobile communications device 100. It can also interface with the applications listed above such that the LCD screen 150 can display an image or graphic that is viewable around the contoured window of NISSHA™ foil or two sided printing can be implemented to create a logo or design icon and related to one or more functions associated with the application.

For instance, a ringer application 440 can be configured to display an image on LCD screen 150. The image can be manipulated any number of ways to provide a graphical indicator to the user as to the importance of the incoming call. Certain telephone numbers may be linked to varying degrees of importance on a color coded scale. Then, when a call comes in from a number associated with one of the colors, the LCD screen beneath logo/icon covering can present a color graphic that can flash, vary its intensity, move about the LCD screen, etc. in a manner designed to attract the user's attention. Perhaps the call is extremely important. The user has assigned the color green to this telephone number with a flashing characteristic so as to draw attention immediately. The stylized logo/icon then becomes a flashing green beacon.

In another example, the LCD screen 150 beneath the touch sensitive stylized logo/icon protective covering 160 can display the hands of a clock. In such a clock application 480, the user can use his finger to move the hands of the clock to set the current time, set the time of an appointment, set the time of an alarm, etc. A calendar may also be displayed on LCD 150 that permits the user to set the date of an appointment, alarm, etc. . . . using his finger on the touch sensitive protective cover 160.

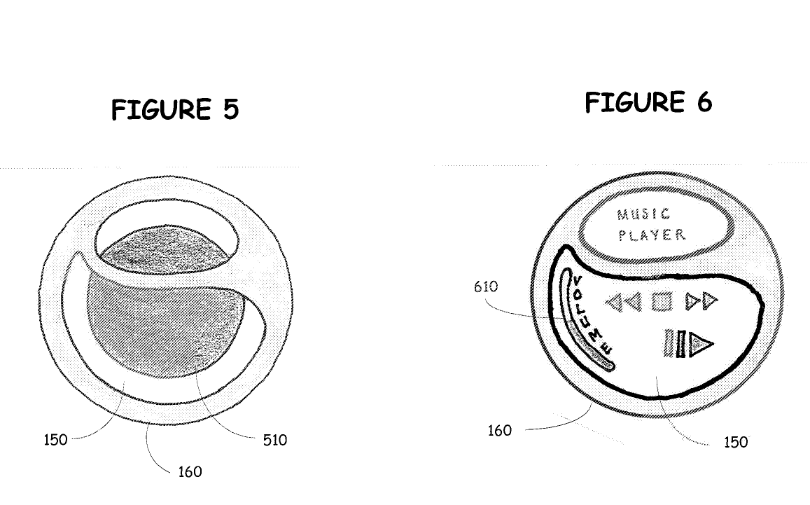

FIG. 5 is one example of a stylized icon that illustrates a company logo that can be made interactive. A touch sensitive protective cover 160 having an integrated touch sensitive layer 165 has been formed in the shape of the Sony Ericsson corporate logo using, for instance, the NISSHA IMD and/or IML techniques and molded into the housing over a section of an LCD screen 150. To complete the Sony Ericsson corporate logo, a graphic of a floating ball 510 is presented on LCD 150 within the confines of the logo integrated into the protective cover 160. Since the floating ball is not fixed to the protective cover portion of the logo, it allows for a graphical manipulation so as to create an interactive experience between the log and the user that can be characterized as an electronic pet.

For instance it can turn blue indicating displeasure (its normal color is green) if the portable mobile communications device 100 is shaken or the touch sensitive area is tapped directly. It can turn a warmer shade such as orange or yellow indicating happiness when the touch sensitive area is slowly stroked like a pet. It can be treated like a virtual pet in that it would require certain types of attention to keep it from disappearing (i.e., physical contact at regular intervals such as petting or feeding via touch). It can be programmed as a game where the object is to keep it alive as long as possible. Failure to provide the proper attention could lead to its disappearance, its destruction, or a withering effect. Conversely, the proper attention could be reflected in its vitality, intensity, color, etc.

FIG. 6 is another example of a stylized icon of an embodiment for a music player application. In this example, the LCD screen 150 is covered by the stylized protective cover 160 of a logo or icon. On display is a music player interface 610 that can respond to touch via the touch sensitive layer 165 of protective cover 160. In this example, the buttons associated with a music player such as, play, pause, stop, fast forward, rewind, next track, last track, and volume are laid out on the LCD screen 150 and made responsive to a finger touch to effect the intended function. The user cold control the volume output by motioning along the axis of the volume display.

The LCD screen 150 could also include other music related images that can float about during the playback of the song. These images can be correlated to the type of song being played. For instance, a slow ballad type of song can be correlated to a slow moving gently lit icon that floats about the LCD screen 150. On the other hand, an up-tempo dance/rock/punk type song can be correlated with a fast moving icon that bounces wildly within about the LCD screen 150.

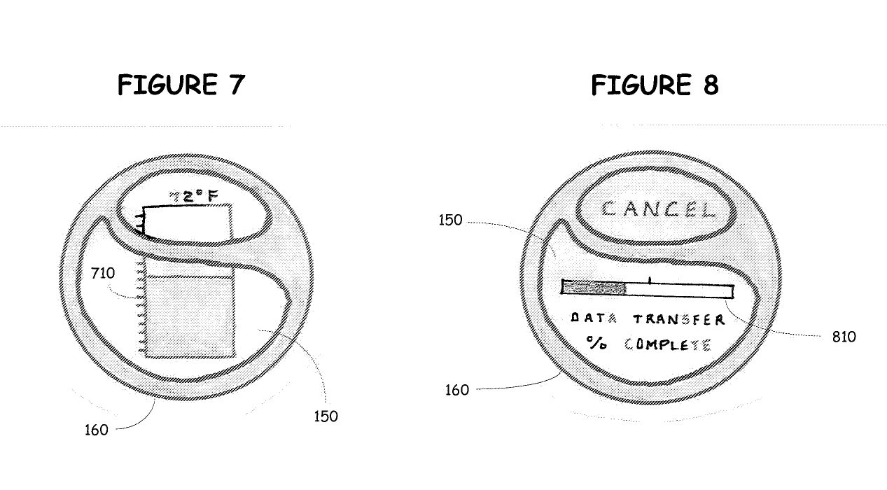

FIG. 7 is yet another example of a stylized icon of an embodiment for an ambient temperature application. Here an image of a thermometer is presented to display the current ambient temperature on the LCD screen 150 as covered by the stylized protective cover 160 of a logo or icon. If the temperature is considered hot, the display icon 710 or background could be made more red. If the temperature is considered cold, the display icon 710 or background can be made more blue. Temperatures in between can be color coded appropriately from red to blue.

FIG. 8 is still another example of a stylized icon of an embodiment for a data transfer application. Here an image 810 is presented that displays the current percentage of data transferred for a desired transaction on the LCD screen 150 as covered by the stylized protective cover 160 of a logo or icon. The image can begin in one color to indicate a small percentage and steadily change colors as the data transfer nears completion. The background can also be made to blink faster as the data transfer nears completion.

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Computer program elements of the invention may be embodied in hardware and/or in software (including firmware, resident software, micro-code, etc.). Embodiments of the invention may take the form of a computer program product, which can be embodied by a tangible computer-usable or computer-readable storage medium having computer-usable or computer-readable program instructions, “code” or a “computer program” embodied in the storage medium for use by or in connection with the instruction execution system. Any suitable tangible computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Any prompts associated with the present invention may be presented and responded to via a graphical user interface (GUI) presented on the display of the portable mobile communications device or the like.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

1. A portable mobile communications device comprising:
an LCD display;
a protective cover covering the LCD display, wherein the protective cover is integrated into the housing of the portable mobile communications device and forms a graphical image or icon that only partially obscures the LCD display allowing visual access to the unobscured portion of the LCD display;
a touch sensitive layer integrated into the protective cover;
a processor coupled with the touch sensitive layer and the LCD display;
a tracking and application software program executable by the processor that interprets touch and position data sensed by the touch sensitive layer and provides feedback or responses based thereon depending on a current mode of operation of the portable mobile communications device; and
a software application executable by the processor and coupled with the tracking and application software program for providing visual graphical output via the LCD display.

2. The portable mobile communications device of claim 1 wherein the protective cover is contoured to provide a depth dimension.

3. The portable mobile communications device of claim 2 wherein the contoured protective cover further comprises a window foil.

4. The portable mobile communications device of claim 2 wherein the contoured protective cover further comprises a two sided printing.

5. The portable mobile communications device of claim 1 wherein the touch sensitive layer comprises a capacitive touch system.

6. The portable mobile communications device of claim 1 wherein the software application is a music player application comprising:
means for displaying icons on the LCD display that indicate control functions that control the playback of music;
means for associating the displayed control functions to the touch sensitive layer such that when the touch sensitive layer detects touch over an area of a control function a signal is conveyed to the processor that causes the execution of instructions to carry out the intended control function;
means for altering the display characteristics of the LCD display in response to the type of music being played by the portable mobile communications device.

7. The portable mobile communications device of claim 1 wherein the software application is an electronic pet application comprising:
means for displaying a pet icon on the LCD display;
means for associating the pet icon to the touch sensitive layer; and
means for altering the display characteristics of the pet icon on the LCD display in response to the sensed touch.

8. The portable mobile communications device of claim 1 wherein the software application is a clock application comprising:
means for displaying a clock face and clock hands on the LCD display;
means for associating the clock face and clock hands to the touch sensitive layer; and
means for altering the time of the clock face and clock hands on the LCD display in response to the sensed touch; and
means for updating an internal clock of the portable mobile communications device based on sensed touch to the clock face and clock hands.

9. A portable mobile communications device comprising:
display means;
protective cover means covering the display means, wherein the protective cover means is integrated into the housing of the portable mobile communications device and forms a graphical image or icon that only partially obscures the display means allowing visual access to the unobscured portion of the display means;
touch sensitive means integrated into the protective cover means;
processor means coupled with the touch sensitive means and the display means;
means for interpreting touch and position data sensed by the touch sensitive means and providing feedback or responses based thereon via the display means depending on a current mode of operation of the portable mobile communications device.

10. The portable mobile communications device of claim 9 wherein the protective cover means is contoured to provide a depth dimension.

11. The portable mobile communications device of claim 10 wherein the contoured protective cover means further comprises a window foil.

12. The portable mobile communications device of claim 10 wherein the contoured protective cover means further comprises a two sided printing.

13. The portable mobile communications device of claim 9 wherein the touch sensitive means comprises a capacitive touch system.

14. A protective cover for an LCD display of a portable mobile communications device comprising:
a contoured foil integrated into the housing of the portable mobile communications device that forms a graphical image or icon that only partially obscures the LCD display allowing visual access to the unobscured portion of the LCD display; and
a touch sensitive layer integrated into the protective cover.

15. A protective cover for an LCD display of a portable mobile communications device comprising:
a contoured two sided printing integrated into the housing of the portable mobile communications device that forms a graphical image or icon that only partially obscures the LCD display allowing visual access to the unobscured portion of the LCD display; and
a touch sensitive layer integrated into the protective cover.
